(19) United States
(12) Patent Application Publication
(10) Pub. No.: US 2021/0055716 A1
(43) Pub. Date: Feb. 25, 2021

(54) DATA HARMONIZATION ACROSS BUILDING LIFECYCLE

(71) Applicant: Gafcon, Inc., San Diego, CA (US)

(72) Inventor: John TURNER, San Diego, CA (US)

(21) Appl. No.: 16/998,225

(22) Filed: Aug. 20, 2020

Related U.S. Application Data
(60) Provisional application No. 62/889,419, filed on Aug. 20, 2019.

(51) Int. Cl. G05B 19/418; G06F 16/28; G06F 16/21; G06F 16/2455

(52) U.S. Cl. CPC G05B 19/41885; G05B 19/4185; G06F 16/2455; G06F 16/212; G06F 16/289

(57) ABSTRACT

Data harmonization across one or more building lifecycles. In an embodiment, a plurality of building information modeling (BIM) objects. At least a subset of the BIM objects comprises higher-level BIM objects that represent assemblies of lower-level BIM objects, at least a subset of the lower-level BIM objects represents manufactured products, and at least a subset of the higher-level BIM objects represents a modular portion of a building. The plurality of BIM objects is stored in a BIM object database on a central server system, and access is provided to the plurality of BIM objects to a plurality of remote software applications via at least one network.

### CROSS-REFERENCE TO RELATED APPLICATIONS

The present application claims priority to U.S. Provisional Patent App. No. 62/889,419, filed on Aug. 20, 2019, which is hereby incorporated herein by reference as if set forth in full.

### BACKGROUND

### Field of the Invention

The embodiments described herein are generally directed to building projects, and, more particularly, to data harmonization and reuse across the lifecycles of serial-building projects.

### Description of the Related Art

The typical lifecycle of a building project comprises five stages: (1) planning; (2) design; (3) procurement; (4) construction; and (5) operation. Conventionally, each of these stages, including the data utilized during each stage, exists within its own separate and distinct silo. Therefore, what is needed are systems and methods for unifying and harmonizing the data used by each silo, such that the data may be reused and efficiently transferred or translated between different silos.

### SUMMARY

Accordingly, systems, methods, and non-transitory computer-readable media are disclosed for data harmonization and reuse across the lifecycles of serial-building projects.

In an embodiment, a method is disclosed that comprises using at least one hardware processor to: generate a plurality of building information modeling (BIM) objects, wherein at least a subset of the BIM objects comprises higher-level BIM objects that represent assemblies of lower-level BIM objects, wherein at least a subset of the lower-level BIM objects represents manufactured products, and wherein at least a subset of the higher-level BIM objects represents a modular portion of a building; store the plurality of BIM objects in a BIM object database on a central server system; and provide access to the plurality of BIM objects, in the BIM object database on the central server system, to a plurality of remote software applications, via at least one network. The method may further comprise constraining generation of the plurality of BIM objects according to one or more guidelines. The plurality of software applications may comprise two or more of a planning platform, a design platform, a procurement platform, a construction platform, or an operations platform. The plurality of software applications may comprise Revit™. The method may further comprise using at least one hardware processor to generate a design model from the BIM objects. The method may further comprise using at least one hardware processor to update the design model into an as-built record model that is compatible with an operations platform. The method may further comprise using at least one hardware processor to control one or more environmental devices within a physical building modeled by the as-built record model. The method may further comprise using at least one hardware processor to generate a consolidated construction model from the BIM objects, wherein the consolidated construction model is compatible with a construction platform. Generating a plurality of BIM objects may comprise receiving at least a portion of the plurality of BIM objects via a planning platform. At least a portion of the plurality of BIM objects may consist of a portion of the plurality of BIM objects, and the portion of the plurality of BIM objects may comprise the lower-level BIM objects. Generating a plurality of BIM objects may comprise receiving at least a portion of the plurality of BIM objects via a design platform. At least a portion of the plurality of BIM objects may consist of a portion of the plurality of BIM objects, and the portion of the plurality of BIM objects may comprise the higher-level BIM objects. Any of these methods may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processed described herein, may be executed, according to an embodiment;

FIG. 3 illustrates utilization of the platform in FIG. 1 throughout the building lifecycle, according to an embodiment;

FIG. 4 illustrates relevant features of a planning stage, according to an embodiment;

FIG. 5 illustrates relevant features of a design stage, according to an embodiment;

FIG. 6 illustrates relevant features of a procurement stage, according to an embodiment;

FIG. 7 illustrates relevant features of a construction stage, according to an embodiment; and

FIG. 8 illustrates relevant features of an operation and maintenance stage, according to an embodiment.

### DETAILED DESCRIPTION

In an embodiment, systems, methods, and non-transitory computer-readable media are disclosed for data harmonization and reuse across the lifecycles of serial building projects. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

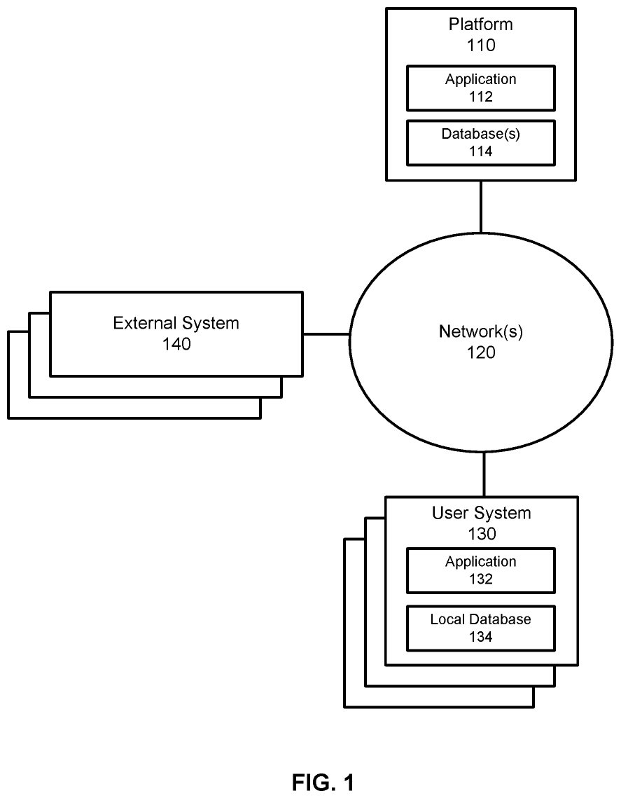

FIG. 1 illustrates an example infrastructure for data harmonization and reuse across the lifecycles of serial-building projects, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the functions, processes, or methods of the application described herein.

1.2. Example Processing Device

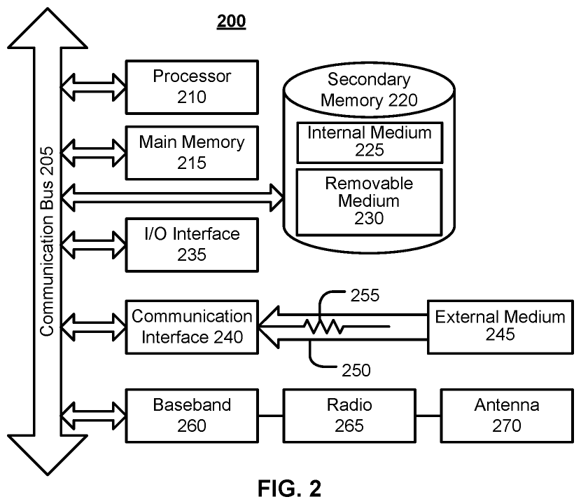

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules of the disclosed application) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as one or more software modules of the disclosed application) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as one or more software modules of the disclosed application) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

2. Process Overview

Embodiments of processes for data harmonization and reuse across the entire lifecycle of serial-building projects will now be described in detail in various embodiments. It should be understood that one or more of the described processes may be embodied in one or more software modules that are executed by one or more hardware processors (e.g., processor 210), e.g., as the application discussed herein (e.g., server application 112, client application 132, and/or a distributed application comprising both server application 112 and client application 132), which may be executed wholly by processor(s) 210 of platform 110, wholly by processor(s) 210 of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by the hardware processor(s) 210, or alternatively, may be executed by a virtual machine operating between the object code and the hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of steps, each process may be implemented with fewer, more, or different steps and a different arrangement and/or ordering of steps. For example, one or more of the disclosed steps may be omitted from each of the disclosed processes. In addition, it should be understood that any step, which does not depend on the completion of another step, may be executed before, after, or in parallel with that other independent step, even if the steps are described or illustrated in a particular order.

2.1. Data Harmonization Across Lifecycle

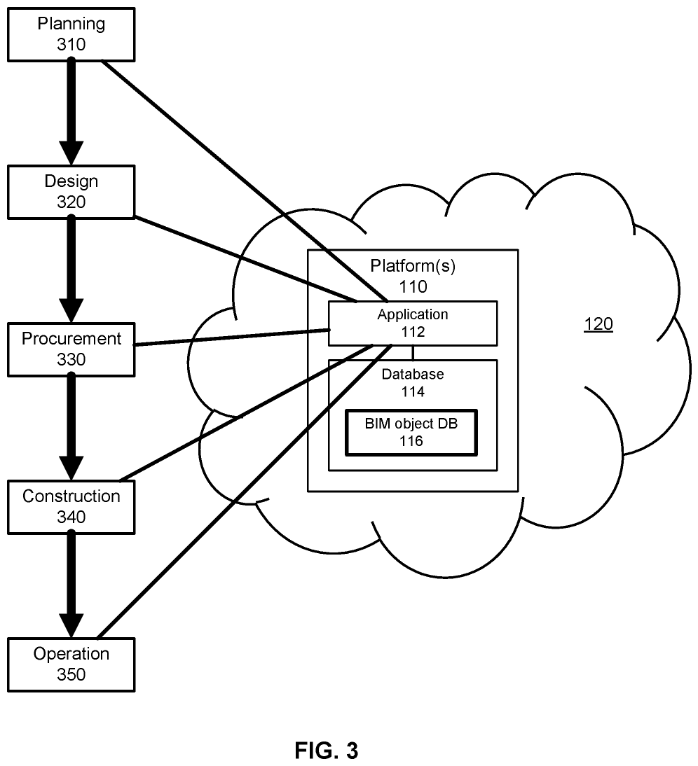

FIG. 3 illustrates how platform 110 is utilized throughout the building lifecycle, according to an embodiment. The typical building lifecycle comprises five stages: (1) planning stage 310; (2) design stage 320; (3) procurement stage 330; (4) construction stage 340; and (5) operation (and maintenance) stage 350. Conventionally, each stage 310-350 exists as a separate and distinct silo from each of the other stages 310-350. Each silo may utilize different software applications, data models, requirements, and/or the like. This makes it very difficult and time-consuming to share data across two or more different stages 310-350, and can render an operation model for a constructed building prohibitively expensive to create.

In an embodiment, the different stages 310-350 are unified by sharing a common data model, which is governed by specified limitations to ensure compatibility with the software used in each stage 310-350. The data model may be implemented using Building Information Modeling (BIM) objects stored in a BIM object database 116 within a database 114 of platform 110, and the specified limitations may be implemented as a set of BIM guidelines. Users within any of stages 310-350 may access BIM object database 116 via server application 112 of platform 110, for example, to create, access, modify, and/or otherwise manage BIM objects stored in BIM object database 116, according to the BIM guidelines. In an embodiment, platform 110 may comprise the BIMObject Cloud, provided by BIMObject Corporation of Malmo, Sweden. The BIMObject Cloud enables users to store, access, publish, search, organize, and manage BIM objects, from a catalog of BIM objects created by the community of users.

A BIM object is a data structure comprising detailed information that defines an object used in a building, including the geometry and attributes (e.g., physical characteristics, behaviors, etc.) of the object. In an embodiment, the data structure used for BIM objects in BIM object database 116 is an open-exchange, platform-neutral format, such as specified by the Industry Foundation Class (IFC) standard.

BIM objects may be combined to form composite BIM objects. Levels may be defined, such that BIM objects at higher levels represent combinations or assemblies of BIM objects at one or more levels below it. For example, there may be six levels of BIM objects:
Level Six: These are the most basic and lowest level of BIM objects. In an embodiment, BIM objects at level six represent component families. These BIM objects represent the basic building blocks for the higher levels. For example, level-six BIM objects may comprise a door, window, unit of a wall, pipe segment, product (e.g., heating, ventilation, and air conditioning (HVAC) unit, chair, desk, etc.), and/or other manufactured components. Essentially, anything that is procured as a single unit, rather than its component parts, should be represented in a level-six BIM object.
Level Five: In an embodiment, a BIM object at level five represents a sub-assembly of two or more of the component families represented by level-six BIM objects.
Level Four: In an embodiment, a BIM object at level four represents a modular assembly comprising two or more of the sub-assemblies represented by level-five BIM objects.
Level Three: In an embodiment, a BIM object at level three represents a modular sector comprising two or more of the modular assemblies represented by level-four BIM objects.
Level Two: In an embodiment, a BIM object at level two represents a building comprising two or more of the modular sectors represented by level-three BIM objects.
Level One: These are the most complex and highest level of BIM objects. In an embodiment, a BIM object at level one represents a site comprising a combination of the building site and one or more of the buildings represented by level-two BIM objects.

Advantageously, an entire building (e.g., level-two BIM object) or site (e.g., level-one BIM object) can be designed within seconds by assembling lower-level assemblies. The reusability of lower-level assemblies is especially advantageous in the context of serial building, in which a plurality of similar or identical buildings (e.g., data centers) are to be constructed. Specifically, the lower-level assemblies may be reused across building projects to quickly create higher-level assemblies. Notably, conventional BIM objects are not provided at such a high level of assembly (e.g., level four to level one). In other words, embodiments described herein may use BIM objects unconventionally to promote fast and efficient design in the serial-building process. Advantageously, this modular approach to design allows high-level assemblies to be created once, and then reused many times throughout the serial-building process, to significantly reduce design durations. Specifically, exact copies of a module, represented in a BIM object, can be reused in the design of many different buildings (e.g., like a Lego™ piece). Thus, the use of the data structures of BIM objects to represent various levels of assembly enables the automation of building design, in a manner that was not previously possible.

If more flexibility is desired for architects (e.g., in design stage 320), more lower-level BIM objects may be provided to BIM object database 116. On the other hand, if less flexibility is desired for architects (e.g., to constrain costs), more higher-level BIM objects and fewer lower-level BIM objects may be made available in BIM object database 116. Thus, any number of BIM object levels may be used.

In an embodiment, each higher-level assembly links to or otherwise references its component lower-level assemblies, such that a change to any of the component lower-level assemblies is immediately reflected in the higher-level assembly. Thus, the higher-level assembly “knows” it is an assembly of other BIM objects via references to those BIM objects. In this manner, all changes to lower-level assemblies are automatically propagated up to higher-level assemblies. For instance, a level-five BIM object may represent a conference room, and be an assembly of (e.g., link to) level-six BIM objects representing a conference table and eight instances of the same chair. In this case, if the level-six BIM object representing the chair is modified, this modification will be automatically reflected in all eight instances of the chair in every instance of the level-five BIM object representing the conference room. In other words, each instance of the chair does not have to be separately modified. For example, in an implementation in which Revit™, by Autodesk, Inc. of San Rafael, Calif., is used, changes to a BIM object (e.g., even a higher-level BIM object representing a modular assembly or sector) can be automatically populated to Revit™. Thus, the use of these links in the data structures of BIM objects enables the automation of building design, in a manner that was not previously possible, by providing for automatic propagation of changes in lower-level BIM objects to higher-level BIM objects.

In an embodiment, each BIM object can include a unique asset identifier, which may comprise a reference number, reference string, tag, and/or the like. Higher-level BIM objects can link to lower-level BIM objects by referencing this asset identifier. Notably, it is not required that each of the BIM objects be stored in the same BIM object database 116. Rather, one BIM object in a first BIM object database 116 may reference an asset within a separate BIM object database 116 using an external asset identifier. In addition, the fields in a BIM object may reference external databases (e.g., a database of estimated costs) to retrieve their field values. The use of these external links in BIM objects, again, enables the automation of building design, in a manner that was not previously possible, by providing for automatic population of field values (e.g., real-time values) into the BIM object.

In an embodiment, the BIM objects in BIM object database 116 act as a “Rosetta Stone” for the software applications used in each of stages 310-350. Users in teams across stages 310-350 may access and translate the data they need from a shared set of BIM objects, as well as translate and feed data back into the BIM objects. The manner in which BIM objects are created, modified, and otherwise managed may be strictly regulated—for example, by specified BIM guidelines—to ensure that the BIM objects are compatible with the software applications used in all of stages 310-350. In this manner, the software applications in the various silos of stages 310-350 may communicate with each other via BIM object database 116. It should be understood that the software applications within the same stage 310-350 and/or across different stages 310-350 may communicate with each other and with BIM object database 116 via one or more APIs. In essence, disclosed embodiments replace the human collaboration of conventional systems with data collaboration, providing a faster and more efficient workflow across all of stages 310-350.

2.2. BIM Guidelines

In an embodiment, BIM guidelines are established at the outset of a building project. The BIM guidelines specify the rules for how BIM objects in BIM object database 116 are created, modified, and otherwise managed. The rules may establish what, when, and where information needs to be provided for each BIM object to ensure that each BIM object has the proper content to be compatible across all of stages 310-350, modeling requirements in each stage 310-350, the roles and responsibilities for members of teams within one or more of stages 310-350, the software applications and the configuration of software applications to be used in one or more stages 310-350, the interactions between software applications, the origin and geolocation for the building project (e.g., in real-world coordinates), file types, file naming conventions, how files are to be shared for each project, data standards, level of accuracy and tolerances, coordination process and schedule, collaboration procedures, closeout deliverables, the color to be used for various disciplines (e.g., electrical, mechanical, etc.), how to contract with vendors, how to use data outputs, and/or the like. The BIM guidelines are the foundation for sharing data across lifecycle stages 310-350, and may be identical across serial-building projects (e.g., for identical buildings, for the same owner, etc.), but may differ between different building projects and/or different owners. The BIM guidelines can be used to ensure that the data that is output by upstream systems are compatible with the required input for downstream systems, and that clean data are used throughout the entire building lifecycle, regardless of system or stage.

As an example, the BIM guidelines may require that one or more specified data keys be superimposed onto or otherwise incorporated into the BIM objects in BIM object database 116. For example, the data structure of each BIM object may provide for user-definable data fields. In this case, the data key(s) can be implemented as one or more custom data fields within the data structure of each BIM object. These data key(s) allow associations to be made across different systems within a single stage 310-350 and/or across different stages 310-350. For example, BIM objects may be related to each other by each comprising a shared, identical data key and/or may be related to other data by comprising a data key associated with that other data. Different systems, whether in different stages 310-350 or in the same stage 310-350, may communicate with each other using these data keys.

For instance, one data key in a BIM object may link to cost data associated with a BIM object. The link may be a hyperlink or other reference to a third-party database or platform that monitors and provides estimated installation costs (e.g., real-time or contemporaneous estimates) for the particular object in a region corresponding to the site location. This data may be used in procurement stage 330 (e.g., as an input to a procurement platform). Specifically, the software application used in procurement stage 330 may parse a BIM object, representing a door, to identify the cost of the door, and then follow a link to a third-party platform to retrieve an estimated cost for installing the door within the relevant locality. These estimated costs (e.g., which may be provided in the aggregate for any level of BIM object) can be used as a check on bids from subcontractors. In many cases, general contractors will attempt to obscure their itemized costs, in a black-box bid, for leverage during negotiations. By providing costs for each BIM object (e.g., representing discrete components at level six), owners can force these general contractors to itemize their costs and constrain which subcontractors the general contractors can use (e.g., by forcing general contractors to choose from a subset of subcontractors with the lowest costs for particular components).

As another example, the BIM guidelines may specify how the various software applications in one or more of stages 310-350 are to be configured. The BIM guidelines may specify these software configurations so as to ensure that the various software applications interact with each other in an appropriate and synergistic manner, whether within a single stage 310-350 or across a plurality of stages 310-350. Essentially, the BIM guidelines can integrate disparate systems (e.g., enterprise resource planning (ERP) systems created by different vendors) together into a harmonious collective.

2.3. Planning Stage

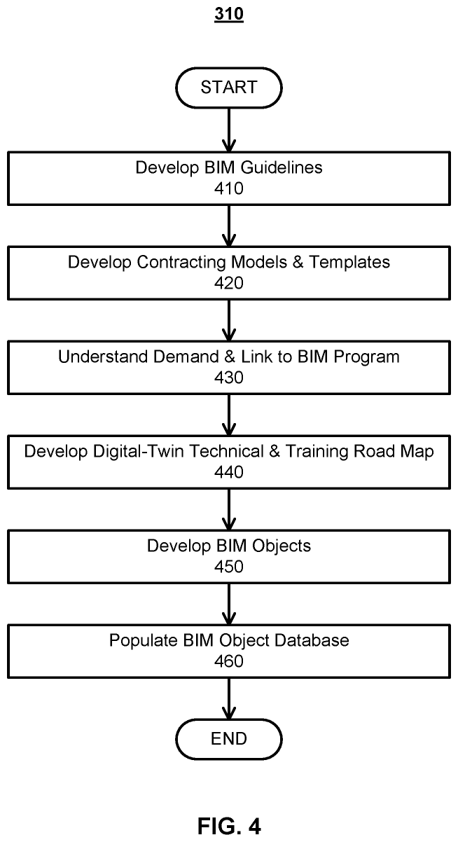

FIG. 4 illustrates relevant features of planning stage 310, according to an embodiment. Systems used in planning stage 310 may include, without limitation, an ERP system, geographic information system (GIS) software, financial modeling, financial forecasting, scheduling, augmented reality, virtual reality, reality capture (e.g., laser scanning and photogrammetry), and/or the like.

In step 410, the BIM guidelines to be used during the building lifecycle are developed. In an embodiment, the BIM guidelines form the set of standards that will be used to enable communication across the silos of stages 310-350. The BIM guidelines may be provided by the owner of a building project to the various participants in the project, including the architect, engineers, general contractor, trade partners, vendors, procurement personnel, operations personnel, all supporting staff, and/or the like. The various teams, individually and collectively, may then discuss and/or modify the BIM guidelines, to produce a final set of BIM guidelines to be published in advance of any activity. Essentially, the teams are working together to agree on the use of a common language, including the definition of keywords (e.g., particularly technical words), how those keywords will be used to communicate intent, and the definition of data elements to be shared across systems (e.g., the definition of data keys and other data fields that enable systems to be integrated). The BIM guidelines may include, without limitation, one or more of the following: an introduction to the complete set of standards; how the standards should be used; to which software applications, the standards should be applied; how the standards should be applied to peripheral software, such as the software used for civil engineering and underground utilities; how two-dimensional sheet views and diagrams will be extracted from the overall BIM three-dimensional data model; the precise meanings of technical terms and data elements; any acronyms that are to be used in the project; the acceptance criteria for deliverables; the detail required in graphic representations; the placement of BIM objects within an absolute coordinate system; how everything will be named; details of the completed and agreed upon data model; all breakdown structures (e.g., particularly those used for work (WBS), organization (OBS), and cost (CBS)); the form of the final BIM deliverable when construction is complete; and/or templates to facilitate the process and communication of process results to the project participants.

In step 420, contracting models and templates are developed. There are many different models of organizational structure, with corresponding legal frameworks, that are used to deliver construction projects. Some of these models are Design/Bid/Build, Design Build, Construction Management at Risk, Integrated Project Deliver, and Progressive Design Build. All of these models have implications with regard to the overall approach to completion of the BIM execution plan, given that there may be legal, commercial, and other conditions that govern what data can be shared, and when and what data is required to be shared and in what form. The overall approach will influence how the procurement and legal contract templates are drafted and completed.

In step 430, an understanding of demand is developed and a link to the BIM software is created. Serial builders intend to build something that is the same or similar based on demand from their customers. Supply and demand should be synchronized as much as possible. This synchronization may involve linking demand with the ability to meet the supply through the construction process and also through the acquisition of long-lead components (e.g., physical components and/or services) that are required in the construction process. The demand can be translated into a form in which its components can be estimated, scheduled, and contracted for, such that an input of demand results in an output of a bill of materials and services that facilitates the building process.

In step 440, a digital-twin technical and training road map is developed. As used herein, the term “digital-twin” refers to a digital replica (e.g., digital model) of a physical building. To implement the building process across all stakeholders and participants, there should be agreement as to the technical platforms to be used and how those platforms are to be configured. This may be done by means of a technical road map that defines the functionality to be available to each team at a particular time or stage of the project. In addition, in order for the teams to be able to use this available functionality, they need to be trained. The training road map specifies the training of teams within adequate time windows.

In step 450, the BIM objects are created. The scope and requirements of the building project will define the BIM objects, including the assemblies and modules (e.g., for one or more levels, such as the six levels discussed elsewhere herein) that will be required for completion. The BIM objects may be specified and assembled prior to or as the first step in design stage 320. This may include the visual representation of the BIM objects, as well as the data attributes and associated documents that will allow the BIM objects to be fully described in the overall process.

For example, the planning team may create and/or select level-six BIM objects and assemble these level-six BIM objects into level-five BIM objects, then assemble the level-five BIM objects into level-four BIM objects, then assemble the level-four BIM objects into level-three BIM objects, and so on and so forth. More generally, the planning team, which may comprise one or more vendors, assembles lower-level BIM objects into higher-level BIM objects. The planning team may assemble BIM objects only to a certain level (e.g., level four), and leave the remainder of the assembly (e.g., assembly of the building in a level-two BIM object) to the design team, which may comprise architects.

The BIM objects may be created, for example, using Revit™. In general, the level-six BIM objects (e.g., component families) will be created from fabrication or product designs and drawings that are simplified into BIM objects. Then, Revit™ may be used to assemble lower-level BIM objects into higher-level BIM objects. Notably, Revit™ is configured to interact with BIM360™, which is also provided by Autodesk, Inc. BIM360™ is design and construction management software comprising a plurality of software tools that are configured to operate from the same Revit™ data. For example, BIM360™ can be used to overlay data (e.g., attributes) onto a model (e.g., BIM object) created using Revit™, view Revit™, civil, and Tekla™ models in two or three dimensions, perform clash-detection, and/or the like.

In step 460, the BIM objects are populated into BIM object database 116 on platform 110. Once the BIM objects have been formed, and the data and documents to which they are associated have been determined, the BIM objects must be loaded into BIM object database 116, so that they can be downloaded into the design platform, and synchronized and accessed throughout the building process, including by other applications in other silos. For example, the BIM objects may be published in the BIMObject Cloud, such that they are accessible by teams in subsequent stages of the building lifecycle (e.g., stages 320-350).

2.4. Design Stage

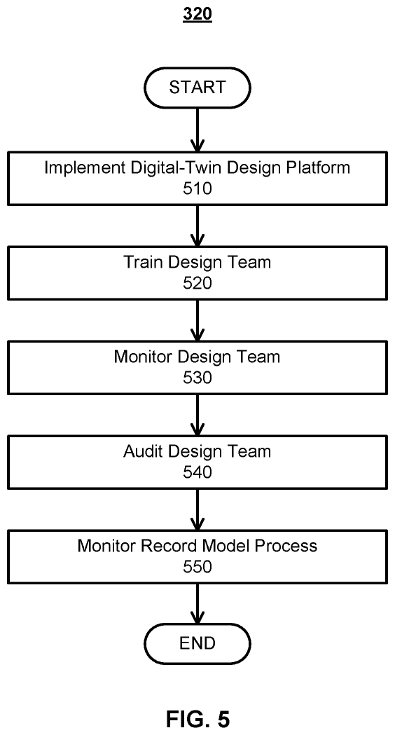

FIG. 5 illustrates relevant features of design stage 320, according to an embodiment. Systems used in design stage 320 may include, without limitation, design authoring software (e.g., for all disciplines), civil engineering authoring software, technical specifications, an ERP system, GIS software, financial modeling, financial forecasting, scheduling, programming management information systems, augmented reality, virtual reality, and/or the like.

In step 510, the digital-twin design platform is implemented. The design platform is used to support the creation or authorship of the design model in the digital-twin workflow. The design platform may be a stand-alone, single-user platform or a collaborative, multi-user platform (e.g., a real-time, collaborative, multi-user platform). In either case, the design platform should be configured for use in accordance with the BIM guidelines.

In step 520, the design team is trained. Specifically, the design team is trained in the use of the design platform and the procedures to be applied to the design platform.

In step 530, the design team is monitored as it consumes the lower-level BIM objects, created in planning stage 310, to create higher-level BIM objects. Oversight is provided to ensure that the design team complies with the use of the design platform and produces the desired outputs (e.g., according to the BIM guidelines). In an embodiment, the design team can only utilize BIM objects within BIM object database 116. However, it is possible that the design team may coordinate with the planning team (e.g., vendors) to add new lower-level BIM objects to BIM object database 116, if necessary. Again, the BIM objects may be created, for example, using Revit™, and may be operated upon within BIM360™.

In an embodiment, the grid on which a model of the building is created may be stored as a BIM object (e.g., which is combined with high-level BIM objects). The grid may be created in Revit™ and tied to the site by real-world coordinates. Generally, the site does not need to be represented in a BIM object, since it is unique, and therefore, not typically reusable across serial-building projects.

In step 540, the design team is audited. Specifically, at certain designated milestones in design stage 320, the design process will be audited to confirm that the desired outputs are being produced in the desired form (e.g., according to the BIM guidelines).

In step 550, the record model process is monitored. A record model is produced upon completion of construction stage 340. The record model may be produced by the design team, based on the final design model, which has been updated to reflect as-built conditions and geometry. The as-built conditions may be communicated through the changes that the builder (e.g., general contractor and subcontractors) made in converting the final design model into a construction model. Alternatively, the as-built conditions may be collected via laser-scanning, photogrammetry, and/or other as-built techniques.

In an embodiment, the record (or design) model comprises a Revit™ model that can be interpreted within BIM360™. The BIM guidelines may specify how to construct the Revit™ model so that it can be properly used by each of the various software tools within BIM360™. In addition, the BIM guidelines may specify how to use the various software tools within BIM360™ (e.g., how to configure each software tool) to operate on the Revit™ model. In an embodiment, the BIM objects are constructed as three-dimensional (3D) components, such that it is possible to use the record model to generate a 3D virtual-reality (VR) walk-through of the represented building (e.g., via an Oculus™ headset) and/or an augmented reality view within a building or at a site (e.g., via Microsoft Hololens™)

2.5. Procurement Stage

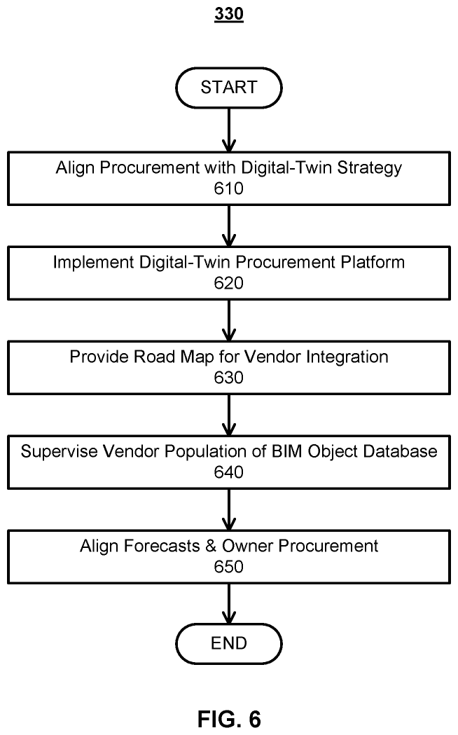

FIG. 6 illustrates relevant features of procurement stage 330, according to an embodiment. Systems used in procurement stage 330 may include, without limitation, a procurement system, forecasting systems (e.g., for inventory), an ERP system, financial modeling, financial forecasting, scheduling, programming management information systems, and/or the like.

In step 610, the procurement process is aligned with the digital-twin strategy. Procurement is the junction between the translation of the demand for facilities to support business operations (i.e., delivered through the construction process), the decomposition of that demand into the components of the construction process (e.g., including owner-furnished equipment, contractor-furnished equipment, services procurement and contracts, and internal resource allocation), and the execution of the construction process in terms of the coordination of all the inputs, into a coordinated procurement and construction schedule. All processes and systems should be aligned to facilitate this junction. The data specified for the BIM objects are specifically designed to support these multiple, intersecting, and aligned workflows.

In step 620, the digital-twin procurement platform is implemented. Specifically, the systems to support the procurement process are procured, configured, and released to the procurement team. This includes platform 110 that supports BIM object database 116.

Examples of procurement platforms include Oracle Fusion™ and SAP Ariba Buying and Invoicing™. One example of a subsystem within an overall procurement platform is provided by Assemble Systems of Houston, Tex., which is an Autodesk™ company. Assemble™ consumes the same Revit™ model as BIM360™, but utilizes the data to produce procurement information, such as the number of objects (e.g., doors, windows, etc.) required for construction, the types and instances of objects, the types and amounts of materials required for construction, and estimated costs for procuring the objects and materials. Each BIM object in the Revit™ model can be associated with a cost and a phase of construction, and linked to a construction schedule.

Assemble™ may be constrained using higher-level BIM objects (e.g., sub-assemblies, modular assemblies, modular sectors, etc.) to estimate the aggregate cost of a particular module as a whole. A materials and installation cost can be determined for each module represented by a high-level BIM object.

In step 630, a road map for vendor integration is provided. BIM object database 116 may be populated by the vendors who provide the various equipment, sub-assemblies, assemblies, modules, or other objects that will be used during construction stage 340. Accordingly, the system specifications may be developed, the system may be configured, and the vendors may be chosen, briefed, and trained to populate BIM object database 116 with appropriate BIM objects (e.g., according to the BIM guidelines).

In step 640, one or more vendors are supervised as they populate BIM object database 116. The vendors' population of BIM object database 116 may be supervised, and the quality of the content may be confirmed prior to use.

In step 650, forecasts are aligned with owner procurement. Specifically, the inputs from the demand forecast may be aligned with the digital-twin process to facilitate the procurement process and to schedule the equipment to projects in a coordinated manner.

In an embodiment, procurement stage 330 may link back to planning stage 310. For example, long-lead items can be identified in planning stage 310. These long-lead items can then be procured early or in volume (e.g., for a serial-building project, to obtain discounts) in an early procurement stage 330.

2.6. Construction Stage

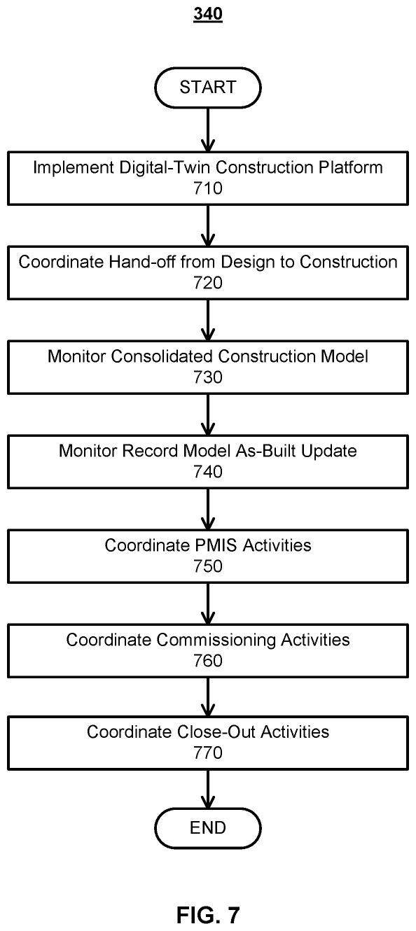

FIG. 7 illustrates relevant features of construction stage 340, according to an embodiment. Systems used in construction stage 340 may include, without limitation, construction authoring software (e.g., for all disciplines), civil engineering authoring software, as-built modeling systems, an ERP system, GIS software, financial modeling, financial forecasting, scheduling, programming management information systems, building layout (e.g., Total Station™), augmented reality, virtual reality, reality capture, and/or the like.

In step 710, the digital-twin construction platform is implemented. The construction platform is used to support the creation or authorship of the consolidated construction model in the digital-twin workflow. Generally, this should be a collaborative, multi-user platform (e.g., a real-time, collaborative, multi-user platform). The construction platform should be configured for use in accordance with the BIM guidelines, and should be able to fully leverage the design model that was created in design stage 320. In some cases, the creation of the consolidated construction model may overlap the timeline for the creation of the design model. This may occur when design stage 320 is approached in phases, by discipline, or in an interactive manner, as may be required by delivery frameworks (e.g., such as Design Assist, Design Build, Progressive Design Build, and Integrated Project Delivery).

In step 720, the hand-off from the design team to the construction team is coordinated. There must be a model hand-off from design stage 320 to construction stage 340. The timing and process for this hand-off will depend on the individual requirements of the building project, including the delivery framework to be used. This hand-off may also involve a contractual hand-off of accountability and responsibility. Therefore, the hand-off should be carefully coordinated and documented.

During the hand-off, clash detection may be performed (e.g., using a software tool of BIM360™) to ensure that the data being handed off is capable of being consumed by the construction platform. Thus, for example, a clash-free design model (e.g., Revit™ model) may be handed over to the general contractor for construction. Conventionally, it was not always possible to do full clash-detection during hand-off to the construction team, as the design model may not have been fully detailed or complete as to all components of the building and equipment. However, in an embodiment, the BIM guidelines ensure that the design model is of sufficient detail that the general contractor does not need to add or modify any components (e.g., BIM objects). For example, in a typical design stage, the architects will not model every component to be used during the construction process (e.g., a block of concrete to contain the movement of water pipes). In contrast, in an embodiment of design stage 320, the BIM guidelines require the architects on the design team to model all components to be used during construction, thereby enabling the performance of full clash-detection during the hand-off in step 720.

After the hand-off, the general contractor or their trade sub-contractors will typically produce construction drawings from the clash-free design model. The construction drawings will be used for actual physical construction of the building on its site.

In step 730, the consolidated construction model is monitored. The design model from design stage 320 evolves into the consolidated construction model by adding additional detail and information related to the fabrication and installation of components, sub-assemblies, and assemblies. Some of the modules may be pre-fabricated or fabricated on site for installation as a sub-assembly or assembly. The evolution of the consolidated construction model is supervised to ensure that the construction team complies with the BIM guidelines, concerning use of the construction platform, to produce the desired outputs.

The general contractor uses the consolidated construction model throughout construction. The consolidated construction model has a relatively high level of development (LOD). Specifically, the LOD (e.g., 400) of the consolidated construction model is higher than the LOD (e.g., 300) of the record model to be used in operations stage 350. Accordingly, the consolidated construction model is separate from the record model.

In step 740, the update of the record model to an as-built record model is monitored. If changes have been made during construction (e.g., a change in components used, location of components, etc.), the design model (e.g., Revit™ model) is updated to become an as-built record model. Any changes to the design model that must be reflected in the record model (e.g., because of changes in the consolidated construction model) should be monitored so that the record model can be appropriately updated.

In the U.S., the general contractor generally does not produce a record model. Rather, the general contractor must communicate with the architect from the design team, and the architect must amend the design model to make it a record model. For instance, after construction is complete, the consolidated construction model is used by the architect on the design model to produce a record model (e.g., Revit™ model) with lower LOD than the consolidated construction model. The record model is owned by the owner of the building project, but is the responsibility of the architect.

In step 750, activities with the Project Management Information System (PMIS) are coordinated. Changes to the consolidated construction model, as well as to the building and fabrication process itself, creates the need for transparency, visibility, and control of all activities by coordinating across all involved parties. This will include the overall project management, cost management, contract and procurement management, schedule management, document management, reporting and the management of issues, risks, and audits. The process by which this is done may be synchronized with the creation of the various models and the transactions that are part of the building and fabrication process, so that a full data model is available. The full data model may involve perspectives on the model and associated two-dimensional drawings and diagrams, the scheduling of activities, the estimation, budgeting, commitment, forecasting, and management of costs, the management of assets (e.g., including procurement, delivery, installation, commissioning and recording of serial numbers, warranty information, and other supporting information), and the management and confirmation of any simulations.

In step 760, commissioning activities are coordinated. In an embodiment, the commissioning of activities is coordinated across all workflows, including procurement, factory acceptance, installation and testing, system testing, and overall integration into associated systems.

In step 770, the close-out activities are coordinated. For instance, all relevant data from design stage 320 and construction stage 340 may be coordinated and prepared to be consumed by the operation platform in operation stage 350.

2.7. Operation Stage

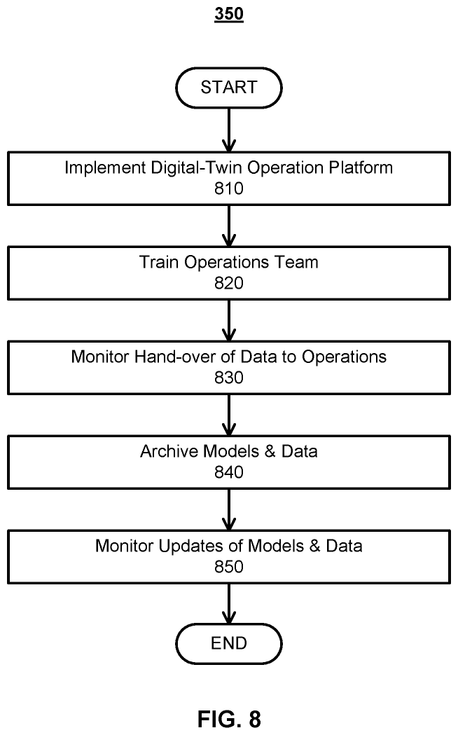

FIG. 8 illustrates relevant features of operation (and maintenance) stage 350, according to an embodiment. Systems used in operation stage 350 may include, without limitation, facilities management systems (e.g., Integrated Workplace Management System (IWMS)/Computer Maintenance Management System (CMMS)), Digital Twin™ for operations, an ERP system, GIS software, financial modeling, financial forecasting, scheduling, augmented reality, virtual reality, reality capture, and/or the like.

In step 810, the digital-twin operation platform is implemented. The operation platform is used to access the relevant data for operating the constructed building. The operation platform may be a collaborative, multi-user platform (e.g., a real-time, collaborative, multi-user platform). The operation platform should be configured for use in accordance with the BIM guidelines, and be capable of fully leveraging the as-built record model that was created by the design and construction teams. As one example, the operation platform may comprise the products (e.g., WillowTwin™, WillowDigital™, etc.) of Willow Inc. of Sydney, Australia. In an embodiment, the operations platform, once populated with data, enables an operator to monitor and control operations (e.g., zoned climate control) of the building in real time, for example, via sensors and controllers/actuators installed in the building.

In step 820, the operations team is trained to use the operation platform that was implemented in step 810.

In step 830, the hand-over of data to the operations team is monitored. Specifically, the record model is used to populate the operation platform. The flow of data from design stage 320 and construction state 340 into the operation platform should be managed, monitored, and audited to ensure the data's accuracy and relevance.

Advantageously, utilization of the BIM guidelines throughout stages 310-340 ensures that the data in the BIM objects in BIM object database 116 are compatible with and consumable by the operation platform with little or no manual effort. All of the BIM objects are accessible via the record model (e.g., Revit™ model) used for operations. Specifically, the record model may link back to specific BIM objects with their specific details (e.g., a BIM object representing a chair in a particular color).

In step 840, the models and data, which are not immediately required to operate the building, are archived so that they remain accessible.

In step 850, over the remainder of the building's life, any updates to the archived models and data are monitored. For example, any changes to the building (e.g., caused by repair, revamping, repurposing, etc.) are reflected in the overall data set, whether or not they are necessary for current operations, since they may potentially be necessary for downstream activities.

Notably, since all of the data are standardized (e.g., using consistent naming conventions), the data can be easily searched. Conventionally, searching would be difficult, since there is no means to link data and sources of data across all of stages 310-350. However, in embodiments that utilize BIM guidelines to define naming conventions, a user can easily search the models in any of stages 310-350 for a particular piece of equipment by name, since the name can be easily determined with reference to the naming conventions.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
generate a plurality of building information modeling (BIM) objects, wherein at least a subset of the BIM objects comprises higher-level BIM objects that represent assemblies of lower-level BIM objects, wherein at least a subset of the lower-level BIM objects represents manufactured products, and wherein at least a subset of the higher-level BIM objects represents a modular portion of a building;
store the plurality of BIM objects in a BIM object database on a central server system; and
provide access to the plurality of BIM objects, in the BIM object database on the central server system, to a plurality of remote software applications, via at least one network.

2. The method of claim 1, further comprising constraining generation of the plurality of BIM objects according to one or more guidelines.

3. The method of claim 1, wherein the plurality of software applications comprises two or more of a planning platform, a design platform, a procurement platform, a construction platform, or an operations platform.

4. The method of claim 1, wherein the plurality of software applications comprises Revit™.

5. The method of claim 1, further comprising using at least one hardware processor to generate a design model from the BIM objects.

6. The method of claim 5, further comprising using at least one hardware processor to update the design model into an as-built record model that is compatible with an operations platform.

7. The method of claim 6, further comprising using at least one hardware processor to control one or more environmental devices within a physical building modeled by the as-built record model.

8. The method of claim 1, further comprising using at least one hardware processor to generate a consolidated construction model from the BIM objects, wherein the consolidated construction model is compatible with a construction platform.

9. The method of claim 1, wherein generating a plurality of BIM objects comprises receiving at least a portion of the plurality of BIM objects via a planning platform.

10. The method of claim 1, wherein generating a plurality of BIM objects comprises receiving a portion of the plurality of BIM objects via a planning platform, wherein the portion of BIM objects comprises the lower-level BIM objects.

11. The method of claim 1, wherein generating a plurality of BIM objects comprises receiving at least a portion of the plurality of BIM objects via a design platform.

12. The method of claim 1, wherein generating a plurality of BIM objects comprises receiving a portion of the plurality of BIM objects via a design platform, wherein the portion of BIM objects comprises the higher-level BIM objects.

13. The method of claim 1, wherein generating a plurality of BIM objects comprises:
receiving a first portion of the plurality of BIM objects via a planning platform; and
receiving a second portion of the plurality of BIM objects via a design platform,
wherein the design platform is separate and distinct from the planning platform.

14. The method of claim 13, wherein the first portion of BIM objects comprises the lower-level BIM objects, and wherein the second portion of BIM objects comprises the higher-level BIM objects.

15. A system comprising:
at least one hardware processor; and
one or more software modules that, when executed by the at least one hardware processor,
generate a plurality of building information modeling (BIM) objects, wherein at least a subset of the BIM objects comprises higher-level BIM objects that represent assemblies of lower-level BIM objects, wherein at least a subset of the lower-level BIM objects represents manufactured products, and wherein at least a subset of the higher-level BIM objects represents a modular portion of a building,
store the plurality of BIM objects in a BIM object database on a central server system, and
provide access to the plurality of BIM objects, in the BIM object database on the central server system, to a plurality of remote software applications, via at least one network.

16. A non-transitory computer-readable medium having instructions stored therein, wherein the instructions, when executed by a processor, cause the processor to:
generate a plurality of building information modeling (BIM) objects, wherein at least a subset of the BIM objects comprises higher-level BIM objects that represent assemblies of lower-level BIM objects, wherein at least a subset of the lower-level BIM objects represents manufactured products, and wherein at least a subset of the higher-level BIM objects represents a modular portion of a building;
store the plurality of BIM objects in a BIM object database on a central server system; and
provide access to the plurality of BIM objects, in the BIM object database on the central server system, to a plurality of remote software applications, via at least one network.
